(19) United States
(12) Patent Application Publication
(10) Pub. No.: US 2002/0127315 A1
(43) Pub. Date: Sep. 12, 2002

(54) Process for preparing french fried potatoes having an extended shelf life at refrigerated temperatures and a reduced reconstitution time

(76) Inventors: Craig Howard Doan, Weiser, ID (US); Dwane Bert Benson, Payette, ID (US); James E. Matthews JR., Wexford, PA (US)

Correspondence Address: Regis E. Slutter, BURNS, DOANE, SWECKER & MATHIS, L.L.P., P. O. Box 1404, Alexandria, VA, 22313-1404, US

(21) Appl. No.: 09/800,673

(22) Filed: Mar. 8, 2001

(51) Int. Cl. A23B 4/00

(52) U.S. Cl. 426/399

(57) ABSTRACT

Potato pieces are processed after a primary process by passing the potato products, preferably frozen or chilled, through a pasteurization process. The pasteurization process includes passing the potato products through an impingement oven, a steam tunnel, an ultra violet (UV) light exposure tunnel, radurization equipment, or combinations thereof, for thermal and/or non-thermal pasteurizing, in a clean room, to reduce or eliminate microbial load on the potato pieces.

### BACKGROUND OF THE INVENTION

1. Field of the Invention

The present invention relates to a process for preparing French fried potato products for freezing and/or refrigeration and subsequent finish dip frying, oven baking, microwave oven cooking, or pan frying reconstitution, and more specifically to a process for giving a pre-fried potato product extended shelf life at refrigeration temperatures.

2. Related Art

Frozen, pre-fried potato products are widely accepted by consumers in both retail and institutional settings and the art of preparing the pre-fried potato products has expanded widely. Typically, whole potatoes are washed, optionally peeled, cut into strips and/or other shapes, blanched, par-fried, and frozen to produce the product consumers or institutional food service workers reconstitute into a finished product. The time required to reconstitute frozen potato products varies with the size and density of the product, the amount of the product being prepared, and the temperature of the product before reconstitution, and can typically range from 15 to over 30 minutes, while refrigerated potato products typically require less time for reconstitution than frozen potato products.

Many refrigerated potato products are widely available to the retail shopper, as well as the institutional buyer, that offer seasoned or unseasoned, cut and blanched type potato products. Prior attempts in the art at producing a refrigerated potato product line having an extended shelf life and excellent flavor and texture qualities upon reconstitution have, however, not been successful. Such attempts have been concentrated upon producing non-par-fried and non-battered potato product items that have little value added. These prior products also lack flavor, and have poor textural qualities upon reconstitution.

There continues to exist, therefore, a substantial need for an improved process for preparing par-fried frozen or refrigerated potato products that have an extended shelf life at refrigerated temperatures which can be reconstituted by dip frying, oven baking, microwave cooking, or pan frying in a reduced period of time.

### SUMMARY OF THE INVENTION

According to a first exemplary embodiment, a method of preparing French fried potato pieces comprises the steps of obtaining chilled, par-fried potato pieces, and surface pasteurizing the potato pieces in a pasteurization apparatus having an exit into a clean room environment.

Still other objects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 illustrates a flow chart of a par-fried potato product primary processing line; and

FIG. 2 illustrates a flow chart of a secondary processing line.

### DETAILED DESCRIPTION OF PREFERRED EMBODIMENTS

When referring to the drawing figures, like reference numerals designate identical or corresponding elements throughout the several figures.

The present invention relates generally to a process for preparing French fried potatoes which may be frozen or refrigerated and later finish dip fried, oven baked, microwave cooked, or pan fried for reconstitution. According to exemplary embodiments of the present invention, the potatoes are first given primary processing treatments including washing, optional peeling, optional pretreating, trimming, cutting into shapes, blanching, optional coloring, optional drying, optional shaping or forming, par-frying or cooking, and freezing or refrigerating prior to the secondary process.

The present invention also includes a secondary process performed after the foregoing primary process. The primary function of the secondary process, as will be seen below, is to allow product to be processed on an as-needed basis. Product may be passed through the secondary process at any time after the primary process, which enables several advantages including: 1) inventory control; 2) realistic shelf life date coding; 3) off-site processing abilities; and, importantly, 4) reduction of microbial populations on finished product. The secondary process includes passing the potato products, preferably frozen or chilled, more preferably received from the last step of the foregoing primary process, through an pasteurization process. According to preferred embodiments, the pasteurization process includes passing the potato products through an impingement oven, a steam tunnel, an ultra violet (UV) light exposure tunnel, or irradiated (radurized), or combinations thereof, for pasteurizing.

In the context of the present invention, an impingement oven, a steam tunnel, a UV light exposure tunnel, and/or radurization will be referred to collectively as “pasteurization apparatus”. Pasteurization apparatus in accordance with the present invention includes thermal and non-thermal processing equipment which can be used to destroy, kill, or neutralize disease-producing organisms to within an acceptable population density, preferably zero, to destroy, kill, or neutralize spoilage organisms to within an acceptable population density, also preferably zero, or both. However, as will be readily apparent to one of ordinary skill in the art, pasteurization apparatus in accordance with the present invention is not limited to these specific embodiments, and the present invention relates more generally to any apparatus which is capable of reducing microbial populations on food, and particularly potato products.

In the context of the present invention, an impingement oven refers to a hot air oven that delivers high volumes of heated air that is forced through small openings or orifices to increase the velocity of the air that is then forced into contact with a product. A steam tunnel refers to a tunnel that delivers high volumes of steam-based heat to a product at a high mass flow rate. An ultra violet light tunnel refers to a tunnel that delivers UV light, a known bactericidal agent with the most effective wavelength at about 2600 Å, to products passed under or exposed to the light. As well appreciated by one of ordinary skill in the art, UV light is non-ionizing and is absorbed by cell proteins and nucleic acids, in which photochemical changes are likely produced that can lead to cell death.

The product passes through the pasteurization apparatus into a clean room environment at the exit end of the pasteurization apparatus. The pasteurization apparatus generally functions to reduce the microbial load on the potato products prior to packaging in the clean room. After passing through the pasteurization apparatus, the potato product is re-frozen or chilled in the clean room environment, prior to weighing and packaging into retail and/or wholesale containers also in the clean room environment. The potato product containers are flushed with one or more of various mixtures of food grade gas to replace the existing environment with a modified atmosphere to aid in increasing the shelf life of the products. An example of this food-grade gas mixture would be a ratio of 80% nitrogen, 15% carbon dioxide and 5% oxygen. Other combinations of these gases could also be used as one skilled in the art could determine. Still other gases that could be used include carbon monoxide, argon and sulfur dioxide. The packages are then cased and palletized prior to being placed in frozen or refrigerated storage, and/or shipment.

Processes in accordance with the present invention provide for preparing par-fried potato products for freezing or refrigeration and subsequent finish dip frying, oven baking, microwave oven cooking, or pan frying reconstitution in a reduced period of time, and provide a process for giving a pre-fried potato product extended shelf life at refrigeration temperatures.

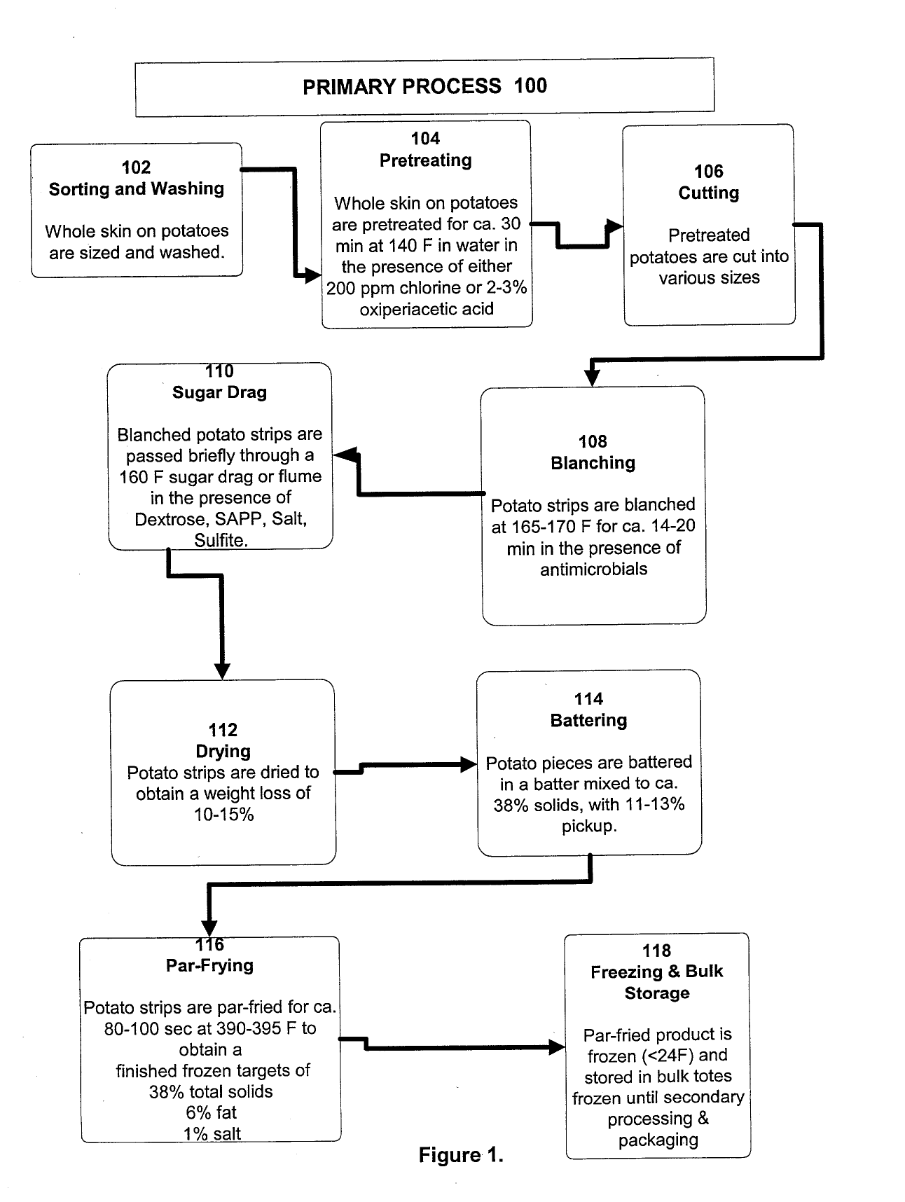

Turning now to the drawing figures, FIG. 1 illustrates a flow chart of a primary potato preparation process 100. As will be readily appreciated by one of ordinary skill in the art, while the process 100 illustrated in FIG. 1 and described below includes a series of steps which are preferably serially performed, additional steps may be added throughout the process, as will be readily apparent to one of ordinary skill in the art, without departing from the scope of the present invention.

Prior to the primary process 100, potatoes may be held in storage under conventional and well known environmental conditions. While any variety of potato can be used in the processes of the present invention, the Russet-Burbank or Russet-Ranger varieties are preferred. In step 102, the whole skin on potatoes are cleaned and washed with a water flume, spray, scrubbers, or other device, and sized prior to peeling. The potatoes are optionally peeled using conventional methods, or by exposing the potatoes to steam or caustic solutions. In step 104, the whole potatoes are optionally pre-treated or tempered in a water bath for between about 10 minutes and about 60 minutes, preferably at least about 30 minutes, at between about 125° F. (51.7° C.) and about 150° F. (65.6° C.), preferably between about 135° F. (57.2° C.) and about 140° F. (60.0° C.). The water bath optionally contains one or a combination of chlorine (preferably about 200 ppm), oxiperiacetic acid (preferably 2%-3% solution), ozone, or any other food grade antimicrobial processing aids.

In step 106, the potatoes are then cut into any number of shapes including French fry strips, wedges, hash brown pieces, slices, cubes, balls, or other shapes. For example, the potatoes can be cut into ⅜ inch by ⅜ inch (0.95 cm by 0.95 cm) French fry strips.

The cut potato pieces are then exposed to a steam and/or water blanching process in step 108 for between about 8 minutes and about 25 minutes, depending on the cut piece size. The blanching temperature in step 108 is preferably between about 160° F. (71.1° C.) and about 220° F. (104.4° C.), depending on the cut piece size and the quality of the raw potato product which entered the process. More preferably, the blanching step 108 is conducted in water at a temperature between about 160° F. (71.1° C.) and about 175° F. (79.4° C.) for between about 12 minutes and about 20 minutes. Even more preferably, the blanching step 108 is conducted in water at a temperature between about 165° F. (73.9° C.) and about 170° F. (76.7° C.) for between about 14 minutes and about 18 minutes, including at least 5-7 minutes of dwell time in the presence of 0.2% sodium metabisulfite. The blanching step 108 serves to soften the potato pieces and leach natural sugars contained within the potato pieces, as well as inactivate enzymes. Further optionally, disodium dihydrogen pyrophosphate (SAPP) at 0.2%, sodium metabisulfate, salt at 2.4%, or combinations thereof can be included in the water used in blanching step 108 to brighten color and as preservatives.

After blanching the potato pieces in step 108, the pieces can be optionally processed in step 110 and passed through a water flume or drag, preferably at about 160° F. (71.1° C.) containing other preservatives including dilute hydrochloric acid, coloring agents such as annatto and the like, or other salts, dextrose, and combinations or mixtures thereof. Preferably, the potato pieces are processed in step 110 concentrated (and maintained) solutions of dextrose at between about 0% and about 1%, SAPP at about 0.2%, sodium chloride between about 1% and about 3%, and sodium metabisulfite at about 0.2%. The potato pieces are passed through the flume or dipped in the drag for between about 10 seconds and about 65 seconds, and preferably for between about 10 seconds and about 30 seconds. The potato pieces can further optionally be passed through an antimicrobial dip, for example dipped in potassium sorbate 0.02% to 0.20% for less than one minute at temperatures between about 40° F. (4.4° C.) and about 75° F. (23.9° C.), to reduce or inhibit the microbial populations of the product.

The potato pieces are then removed from the blanch water, flume, or drag and optionally subjected to a drying step 112. Such drying apparatus are well-known to those of ordinary skill in the art, and will not be detailed herein. The drying step 112 may range between about 4 minutes and about 40 minutes, depending upon the desired moisture content in the dried or finished product. Preferably, between about 4% and about 15%, more preferably between about 10% and about 13%, of the moisture of the potato pieces is removed during the drying process using forced air and heat and turning the product during drying. For example, the potato pieces can be dried for between about 8 minutes and about 30 minutes at between about 150° F. (65.6° C.) and about 160° F. (71.1° C.)

Step 112 can also be replaced with a cooling process. The potato pieces can optionally be subjected to an extended chilling process or retrograding to aid in processing and for the retention and development of desirable texture attributes in the final product. This additional chilling process exposes potato pieces for between about 10 minutes and about 60 minutes at temperatures between about 33° F. (0.6° C.) and about 40° F. (4.4° C.). Optionally, the potato pieces can be allowed to equilibrate or rest, for between 5 minutes and 20 minutes at temperatures between about 40° F. (4.4° C.) and about 75° F. (24° C.).

After drying step 112, the potato pieces are then optionally battered in step 114. As will be readily appreciated by one of ordinary skill in the art, many types or forms of battering equipment can be used, including a simple dipping belt apparatus, prior to being passed under a set of air knives to remove excess batter material.

After the optional battering step 114, the potato pieces are then par-fried in hot oil in step 116. The oil may be any edible oil, including, but not limited to, partially hydrogenated vegetable oil (soybean oil, canola oil, or mixtures thereof). The potato pieces are par-fried for between about 30 seconds and about 3 minutes, preferably between about 80 seconds and about 100 seconds, and more preferably for about 90 seconds, at temperatures between about 350° F. (177° C.) and about 420° F. (216° C.), preferably between about 390° F. (198.9° C.) and about 395° F. (201.7° C.). The par-frying times and temperatures can be varied depending on raw potato solids, batter specifications, potato piece size, and the desired end potato product moisture content, as will be readily apparent to one of ordinary skill in the art. Preferably, the time and temperatures are selected to achieve a finished primary product (when frozen, as discussed below) with about 38% total solids, about 6% fat, and about 1% sodium chloride.

After par-frying in step 116, the potato pieces are frozen and packaged into bulk totes, bins, or other packages, in step 118. For example, the potato pieces can be cooled for between about 12 minutes and about 30 minutes at temperatures between about −20° F. (−29° C.) and about −24° F. (−31° C.). The packaged, frozen potato pieces are then available to be subjected to the secondary process at a later time or, alternatively, the potato pieces are processed in or directly subjected to a secondary process 200, described in greater detail below.

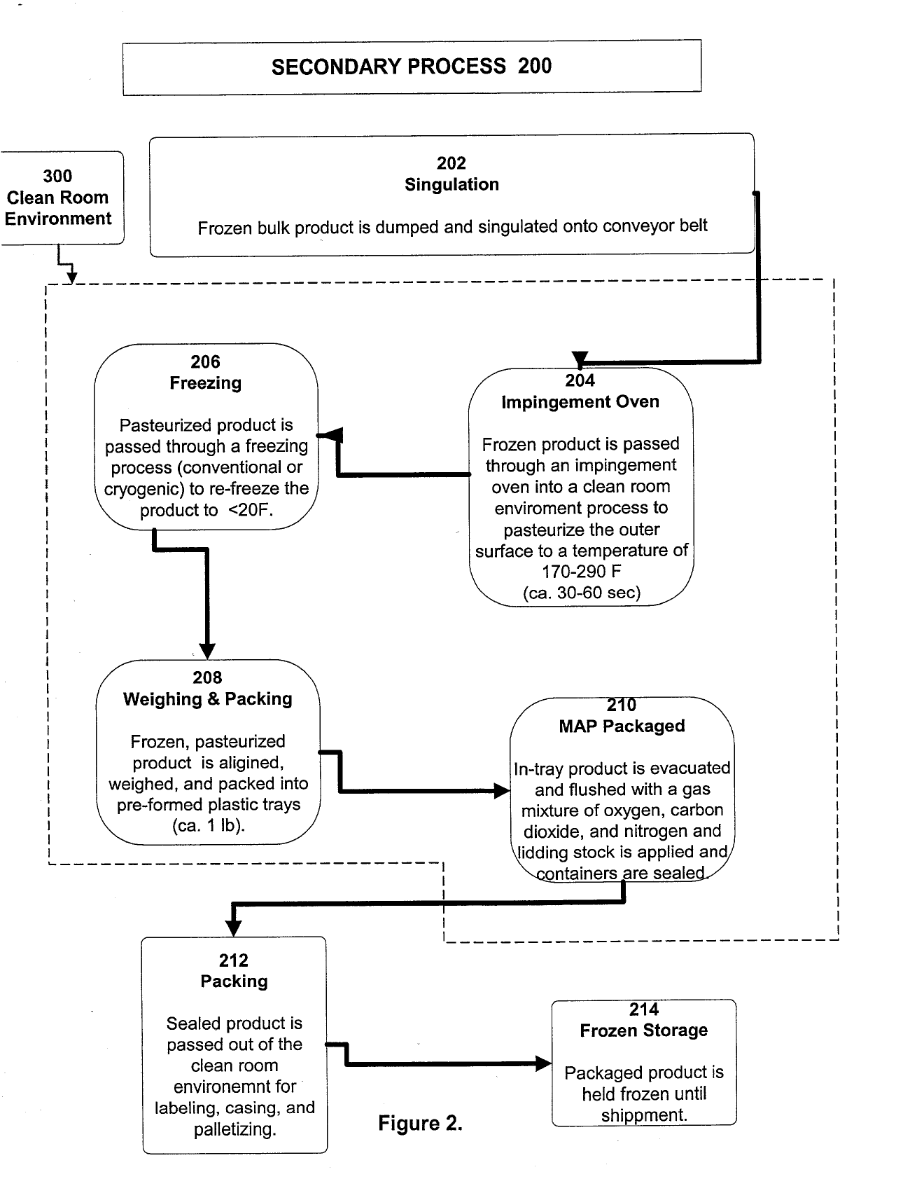

Turning now to FIG. 2, a secondary process is graphically depicted. The secondary process, as mentioned previously, serves to aid: 1) inventory control; 2) realistic shelf life date coding; 3) off-site processing abilities; and 4) reduction of microbial populations on finished product. To prevent and reduce the occurrence of post-pasteurization contamination, all post-pasteurization product processing steps, up to and including final packaging, are performed within a filtered air environment, such as a clean room. In accordance with the present invention, the secondary process begins with step 202 in which potato pieces, preferably processed in accordance with primary process 100 and received after step 118, are singulated or oriented and placed onto a conveyer belt system. The conveyor belt system preferably leads to or is part of a conveyer belt system of a pasteurization apparatus, described elsewhere herein, which performs a pasteurization step 204. The conveyor belt system preferably is oriented such that the entrance end of the process 204 is external of a clean room environment 300 (suggested by the broken line in FIG. 2) and the exit end of the conveyor belt system, including the pasteurization apparatus' conveyer belt system, is internal of or within the clean room environment.

The pasteurization process 204 exposes the singulated potato pieces from step 202 to pasteurizing agent, such as convective or radiative heat, UV radiation, or radurization processed, or the like, to achieve a reduction in the microbial population in the potatoes. For example, a pass-through impingement oven can be used to achieve a surface temperature of the potato pieces of between 170° F. and about 290° F. for between about 30 seconds and about 60 seconds. The pasteurizing step 204 subjects the potato pieces to the pasteurization apparatus to achieve significant microbial contamination reduction.

The clean room environment specifications preferably include HVAC air handling, HEPA filtered to less than 0.3 microns to achieve a class 100,000 standard, and more preferably equal to or better than 100,000 particles no larger than 0.5 microns in size, per cubic foot of air. The clean room environment also has a viable air quality of no more than 2.5 colony forming units (CFU) per cubic foot of air. All personnel within the clean room process are required to wear coveralls, foot coverings, hair nets, and sterile gloves that are adorned within a HEPA filtered gown room equivalent to the above environmental standards.

According to preferred embodiments of the present invention, the pasteurization step 204 produces a final potato product which contains: an aerobic plate count less than 1.0 log CFU per gram (g); a coliform count less than 1.0 log CFU/g; a Escherchia coli count less than 1.0 log CFU/g; a Staphylococcus aureus count less than 1.0 log CFU/g; that is negative for Listeria monocytogenes; that is negative for Salmonella; that is negative for Escherichia coli O157:H7; that is negative for Clostridium botulinum; and a mold and yeast count <1.0 log CFU/g. As methods for measuring the population density count (CFU/g) are well known to those of ordinary skill in the art, a detailed description thereof will not be included herein.

Following step 204 and the exposure of the potato pieces to the pasteurizing process, the product is chilled for immediate regional distribution or frozen for longer, national distribution 206. The product is chilled to 32° F. (0.0° C.) to 40° F. (4.4° C.) or frozen to less than 24° F. (−4.4° C.), more preferably less than 20° F. (−6.7° C.), to aid in product handling, for aseptically weighing, aligning, and dispensing into final packaging inside the clean room in step 208. If the product is exposed to a cooling gas or other freezing apparatus, in step 206, it is also filtered through the HEPA system prior to contact with the product. For example, in step 208, the frozen or chilled potato pieces can be packed into pre-formed plastic trays holding approximately 1 lb (0.454 kg).

After the frozen product is weighed and placed into the final packaging material in step 208, the containers are evacuated and flushed with a modified atmosphere (MAP) in step 210, prior to lidding. The modified atmosphere contains food grade oxygen, carbon monoxide, carbon dioxide, nitrogen, argon, sulfur dioxide, and mixtures thereof. Most preferably the modified atmosphere contains from about 0% to about 5.0% O₂, from about 0% to about 15.0% CO₂, and from about 0% to about 75-80% N₂, and most preferably 80% nitrogen, 10-15% carbon dioxide, and 0-5% oxygen. Thereafter, the packages are lidded with lidding stock, preferably lidding stock with a low oxygen transmission rate ranging from 0 to 10 (cc/100 in²-d-atm) @ 77° F. and 0% relative humidity.

After packaging and lidding, the containers may exit from the clean room environment 300 for casing, labeling, including date code labeling, and palletizing in step 212. Finished packaged product is then held frozen or refrigerated in step 214 until shipping into central distribution.

### EXAMPLE 1

Whole, skin on Russet Burbank or Russet Ranger type potatoes were washed and pretreated (tempered) in water for 30 minutes at 140° F. in the presence of 200 ppm chlorine. The pre-treated potatoes were then sliced into ⅜ inch (0.95 cm)×⅜ inch (0.95 cm) straight cut strips and the slivers were removed mechanically. Potato strips were blanched for 15 min at 167° F. (75° C.) in the presence of 0.2% disodium pyrophosphate (SAPP), 1% sodium chloride, and 0.2% Sodium meta-bi-sulfite. After blanching the potatoes were passed through a hot water drag containing dextrose for 20 seconds at 160° F. (71.1° C.). The potato strips were then dried to achieve a moisture loss of about 10% to 12% prior to battering. The starch-based type batter was mixed to contain 38% total solids at 60° F. (15.6° C.) prior to application to the potato strips. After battering, the potato strips were passed under air knives to control uptake of the batter by the potato strips to about 12%. The battered potato strips were then par-fried for 90 seconds at 395° F. (201.7° C.). Par-fried, battered potato strips were then frozen in a conventional ammonia blast freezer tunnel to a temperature of 22° F. (−5.6° C.) during a 20 minute pass-through, then product was packed into bulk containers and held frozen until the secondary processing steps.

Frozen, battered, par-fried potato strips transferred out of bulk containers and passed into an impingement oven at 525° F. (273.9° C.) for about 50 seconds. The entry of the oven was external of a clean room wall while the exit end of the oven was inside the clean room.

The clean room specifications included HVAC air handling, HEPA filtered to 0.3 microns, to achieve less than 100,000 particles no more than 0.5 microns in size per cubic foot of air, and viable air quality was of no more than 2.5 CFU per cubic foot of air. All personnel within the clean room process wore coveralls, foot coverings, hair nets, and sterile gloves that were adorned within a HEPA filtered gown room. After passing the French fries through the impingement oven, they were again frozen using a liquid nitrogen cryogenic tunnel. After re-freezing the fries, they were aseptically weighed into polyethylene terephthalate (PET) trays in 1 pound (0.454 kg) units.

After the product was weighed, the trays were flushed with a food grade gas mixture consisting of 4.7% O₂, 14.3% CO₂, and 80% N₂ and sealed using an anti-fog mylar lidding film with a low oxygen transmission rate of 0 to 5 (cc/100 in²-d-atm) @ 77° F. and 0% RH.

Total finished frozen solids were 37.0% including about 5.5% oils (63% moisture) and finished frozen salt was about 1%. The finished product pH was about 6.2 and the thawed product (water activity) was about 0.988.

The microbiological analysis for this product were: <1.0 log CFU/g aerobic plate count; <1.0 log CFU/g coliforms; <1.0 log CFU/g Escherchia coli; <1.0 log CFU/g Staphylococcus aureus; <1.0 log CFU/g molds; and <1.0 log CFU/g yeasts. The final product was also negative for Listeria monocytogenes, Salmonella, Clostridium botulinum, and Escherichia coli O157:H7. To provide shelf life information from a food safety standpoint, a controlled microbiological challenge study was initiated.

At 37.4° F. (3° C.), the product shelf life was determined to exceed 60 days. The shelf life was determined by controlled product incubation at 37.4° F. (3° C.) and the absence of Clostridium botulinum toxin production on both inoculated and uninoculated samples. At 44.6° F. (7° C.), the product shelf life was determined to be about 29 days. The shelf life was determined by controlled product incubation at 44.6° F. (7° C.) and the absence of C. botulinum toxin production on both inoculated and uninoculated samples. The reconstitution time, from refrigerated temperatures, needed in a conventional oven at 475° F. (246° C.) was from 10 to 12 minutes. The product was judged to have several attributes by consumers, and comment included: fresher quality; recently made; better flavor; faster preparation time; better texture; and more nutritional value compared to frozen potato products. The product was also found to be improved for attributes including: product size, overall product texture, product oiliness, and salt content compared to frozen potato products.

### EXAMPLE II

Potato strips were processed in the previously described primary processing manner as in Example 1 above. Following the primary processing, the frozen bulk packaged potato strips were transferred out of bulk containers and passed into a UV light exposure tunnel. The entry of the UV tunnel was external of a clean room wall while the exit end of the oven was inside the clean room (as previously described in Example 1). The frozen potato strips were exposed to UV light for about 3 minutes prior to freezing again using a liquid nitrogen cryogenic tunnel. After refreezing, the potato strips were aseptically weighed and packaged (as previously described in Example 1).

The microbiological analysis for this product were: 1.0-2.0 log CFU/g aerobic plate count; <1.0 log CFU/g coliforms; <1.0 log CFU/g Escherchia coli;, <1.0 log CFU/g Staphylococcus aureus; <1.0 log CFU/g molds; and <1.0 log CFU/g yeasts.

While the invention has been described in detail with reference to preferred embodiments thereof, it will be apparent to one skilled in the art that various changes can be made, and equivalents employed, without departing from the scope of the invention.

What is claimed is:

1. A method of preparing French fried potato pieces comprising the steps of:
obtaining chilled, par-fried potato pieces; and
surface pasteurizing the potato pieces in a pasteurization apparatus having an exit into a clean room environment.

2. A method in accordance with claim 1, wherein the surface pasteurizing step comprises surface pasteurizing in a pasteurization apparatus selected from the group consisting of an impingement oven, a steam tunnel, an ultra violet light tunnel, and radurization equipment.

3. A method in accordance with claim 1, further comprising:
chilling the potato pieces in a clean room environment after the step of surface pasteurizing the potato pieces in a pasteurization apparatus.

4. A method in accordance with claim 1, further comprising:
aseptically packaging the potato pieces in a clean room environment after the step of surface pasteurizing the potato pieces in a pasteurization apparatus.

5. A method in accordance with claim 1, further comprising:
packaging the potato pieces in a modified atmosphere in a clean room environment after the step of surface pasteurizing the potato pieces in a pasteurization apparatus.

6. A method in accordance with claim 5, wherein the potato pieces packaged in a clean room environment have a shelf life of at least 60 days at refrigerated temperatures.

7. A method of preparing French fried potato pieces comprising the steps of:
obtaining chilled, par-fried potato pieces; and
surface pasteurizing the potato pieces in a pasteurization apparatus having an exit into a clean room environment, the surface pasteurizing providing at least one final microbial count selected from the group consisting of:
less than 1.0-3.0 log CFU/g aerobic plate count;
less than 1.0 to 1.0 log CFU/g coliforms;
less than 1.0 to 1.0 log CFU/g Escherchia coli;
less than 1.0 to 1.0 log CFU/g Staphylococcus aureus;
less than 1.0 to 1.0 log CFU/g molds; and
less than 1.0 to 1.0 log CFU/g yeasts;
wherein the potato pieces are negative for Listeria monocytogenes, Salmonella, Clostridium botulinum, Escherichia coli O157:H7, and Staphylococcus aureus.
